(19) United States
(12) Patent Application Publication
(10) Pub. No.: US 2020/0214092 A1
(43) Pub. Date: Jul. 2, 2020

(54) METHOD FOR DISTRIBUTED MICROWAVE PHASE CONTROL

(71) Applicant: Industrial Technology Research Institute, Hsinchu (TW)

(72) Inventors: Chia-Ching Huang, Hsinchu (TW); Yueh-Lin Tsai, Hsinchu (TW); Jui-Hung Chen, Hsinchu (TW)

(21) Appl. No.: 16/232,237

(22) Filed: Dec. 26, 2018

(51) Int. Cl. H05B 6/68; H05B 6/72

(52) U.S. Cl. CPC H05B 6/68; H05B 6/72

(57) ABSTRACT

A method of distributively controlling phases is provided, including: inputting, by a plurality of phase-controlled power modules, microwave via each input ports into a chamber, to allow the microwave in the chamber to form a first electric field distribution; and adjusting, by each of the phase-controlled power modules, phases of microwave signals fed into the chamber at each input port, to allow the microwave in the chamber to generate a second electric field distribution complementary to the first electric field distribution due to a phase change.

### BACKGROUND

### 1. Technical Field

This disclosure relates to microwave controlling techniques, and, more particularly, to a method of distributively controlling phases of microwave.

### 2. Description of Related Art

Conventional microwave heating technique is to use a magnetron to generate microwave to heat an object. However, the electric field distribution of the microwave of the conventional microwave heating method is prone to be uneven. Therefore, a portion of the object placed in a weak electric field region absorbs a weak electric field and generates a low heated region, while another portion of the object placed in a strong electric field region absorbs a strong electric field and generates a high heated region. As such, the object is heated unevenly by the microwave.

In addition, in order to increase the temperature of the low heated region, a mechanical turn table or a microwave blender can be used to change the electric field distribution, which, however, offers a limited effect.

Therefore, how to ensure that the whole region is heated evenly is becoming an urgent issue in the art.

### SUMMARY

In an embodiment, a method of distributively controlling phases of microwave according to this disclosure includes: providing a case having a chamber inside, and forming a plurality of input ports in connection with the chamber on the case; inputting microwave, by a plurality of phase-controlled power modules, via the input ports into the chamber to allow the microwave in the chamber to form a first electric field distribution; and adjusting, by the phase-controlled power modules, phases of microwave signals fed into the chamber at each input port, to enable the microwave in the chamber to generate a second electric field distribution complementary to the first electric field distribution due to a phase change.

It is known from the above that since an array of input ports are formed on a case distributively and a plurality of phase-controlled power modules provide microwave of different phases via the input ports into a chamber, the conversion of distribution of strong and weak electric fields of the microwave in the chamber at different stages can be controlled actively, and the microwave has a complementary electric field distribution in the chamber. Therefore, an object in the chamber can be heated evenly in the complementary electric field, thereby improving the problem of the traditional heater that the object cannot be heated evenly.

### BRIEF DESCRIPTION OF DRAWINGS

The disclosure can be more fully understood by reading the following detailed description of the embodiments, with reference made to the accompanying drawings, wherein:

FIG. 1 is a schematic diagram of a system to which a method of distributively controlling phases is applied according to this disclosure;

FIG. 2 is a flow chart of a method of distributively controlling phases of microwave according to this disclosure;

FIG. 3 is a perspective view of input ports on a rectangular case of a first embodiment according to this disclosure;

FIG. 4 shows a diagram of an electric field distribution of a chamber of FIG. 3 according to this disclosure;

FIG. 5 shows an electric field curve diagram between an input port port1 and an input port port2 when the chamber size of FIG. 4 is 2λ*2λ*1λ according to this disclosure;

FIG. 6 shows a schematic diagram of a phase matching wave according to this disclosure;

FIG. 7 shows a diagram of the electric field distribution of the phase matching wave of FIG. 4 in cycles according to this disclosure;

FIG. 8 shows a schematic diagram of an object to be heated that is a round piece placed in the chamber of FIG. 3 according to this disclosure;

FIG. 9 shows the temperature distribution diagram of the object to be heated in FIG. 8 according to this disclosure;

FIG. 10 is a perspective view of input ports on a rectangular case of a second embodiment according to this disclosure;

FIG. 11 shows the temperature distribution diagram of an object to be heated in FIG. 10 according to this disclosure;

FIG. 12 is a perspective view of input ports on a rectangular case of a third embodiment according to this disclosure;

FIG. 13 shows a cross-sectional view diagram of an electric field distribution of a chamber of FIG. 12 according to this disclosure; and

FIG. 14 is a schematic diagram of a cylindrical case according to this disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

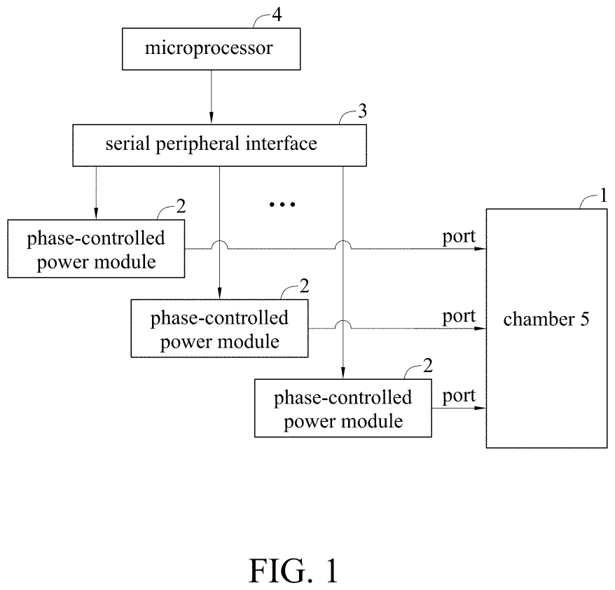

Refer to FIG. 1, which is a schematic diagram of a system to which a method of distributively controlling phases is applied according to this disclosure. The system comprises a case 1 having a chamber 5 inside, a plurality of input ports disposed on the case 1 and being in communication with the chamber 5, a plurality of phase-controlled power modules 2 connected to each of the input ports for inputting microwave via each of the input ports into the chamber 5, a serial peripheral interface 3 connected to each of the phase-controlled power modules 2, and a microprocessor 4 connected to the serial peripheral interface 3 and controlling power and phases of the microwave output by each of the phase-controlled power modules 2 through the serial peripheral interface 3.

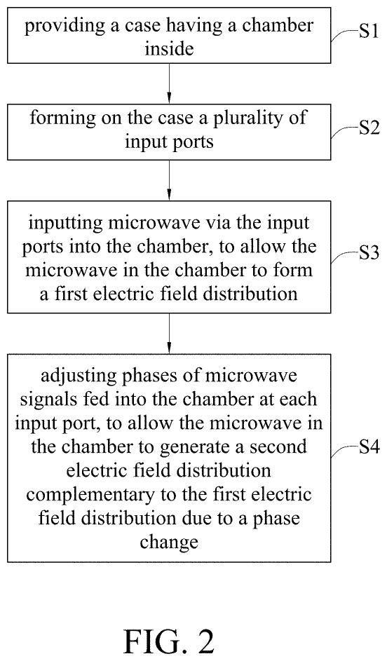

Refer to FIG. 2, which is a flow chart of a method of distributively controlling phases according to this disclosure, including: in step 51 providing a case 1 having a chamber 5 inside; in step S2 forming on the case 1 a plurality of input ports in connection with the chamber 5; in step S3 inputting, by the plurality of phase-controlled power modules 2, microwave via the input ports into the chamber 5, to allow the microwave in the chamber 5 to form a first electric field distribution; and in step S4 adjusting, by each of the phase-controlled power modules 2, phases of microwave signals fed into the chamber at each input port, to allow the microwave in the chamber to generate a second electric field distribution complementary to the first electric field distribution due to a phase change.

In an embodiment, the case 1 is, but not limited to rectangular, cylindrical or polygonal.

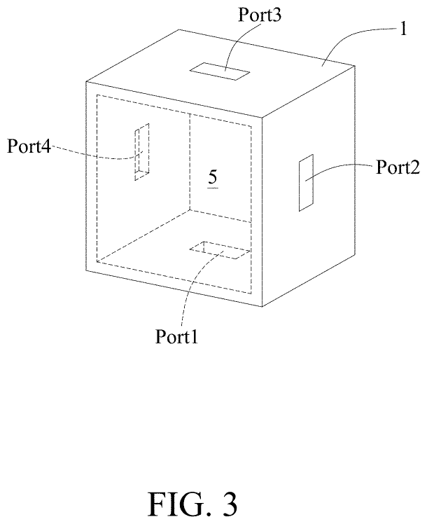

Refer to FIG. 3, which is a perspective view of a plurality of input ports on a rectangular case 1 of a first embodiment according to this disclosure. The plurality of input ports port1-port4 arranged in a ring-shaped array are disposed on the case 1 and symmetrical with respect to horizontal and vertical directions.

In an embodiment, the size of the chamber 5 of the case 1 is, but not limited to an integral multiple of λ (the wavelength of microwave) in the length in Z axis and an integral multiple of λ or an integral multiple of λ added by a half of λ in the length in X axis and in the length in Y axis.

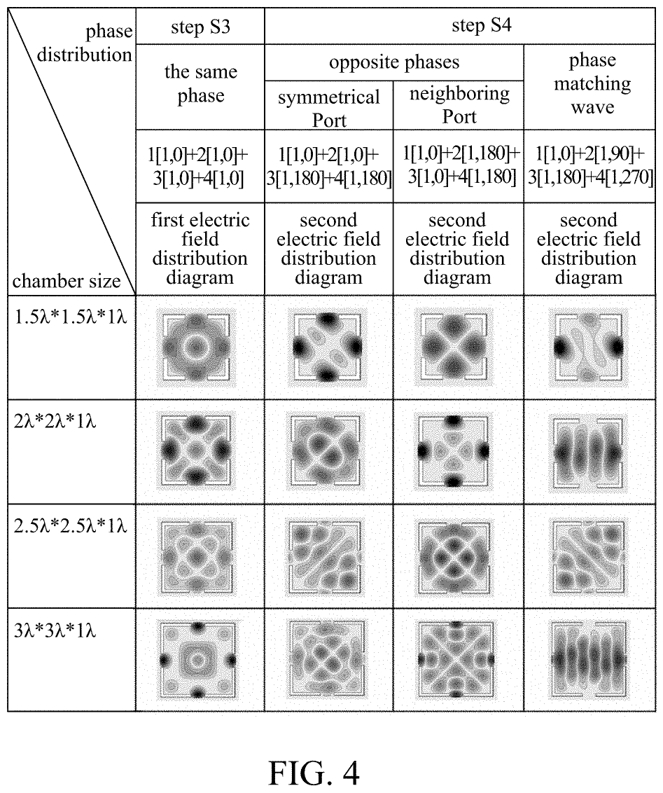

Refer to FIG. 4, which shows a diagram of an electric field distribution of steps S3 and S4 of the method of distributively controlling phases executed by the case 1 of FIG. 3 according to this disclosure. 1[1, 0] indicates the port1 [the power of the peak value is one watt, the phase of the microwave is zero degree] and so on. The size of the chamber 5 of the case 1 can be divided into four types according to the design rules of the chamber 5. The first type is a multiple of 1.5λ*1.5λ*1λ, the second type is a multiple of 2λ*2λ*1λ, the third type is a multiple of 2.5λ*2.5λ*1λ, and the fourth type is a multiple of 3λ*3λ*1λ.

It is known from FIG. 4 that the gray levels determine the strength of an electric field. A light gray level indicates a weak electric field, while a dark gray level indicates a strong electric field. The second electric field distribution is complementary to the first electric field distribution indicates that when a diagram of the second electric field distribution overlaps a diagram of the first electric field distribution, a weak electric field region in a middle region, for example, of the diagram of the first electric field distribution overlaps a strong electric field region in a middle region, for example, of the diagram of the second electric field distribution, or a weak electric field region in the middle region of the diagram of the second electric field distribution overlaps a strong electric field region in the middle region of the diagram of the first electric field distribution.

In step S3, each of the phase-controlled power modules 2 provides microwave of the same phase to each of the input ports port1-port4, let each of the input ports port1-port4 to input the microwave of the same phase into the chamber 5, to allow the microwave in the chamber 5 to the first electric field distribution, wherein the first electric field distribution is in the form of standing waves.

In an embodiment, in step S4 each of the phase-controlled power modules 2 adjusts the microwave input by symmetrical ones of the input ports into the chamber to have opposite phases (e.g., the symmetrical port1 and port3 inputting microwave having opposite phases of 0 and 180 degrees), to allow the microwave in the chamber to generate a second electric field distribution complementary to the first electric field distribution due to a phase change, wherein the second electric field distribution is in the form of standing waves.

In an embodiment, in step S4 each of the phase-controlled power modules 2 adjusts the microwave input by neighboring ones of the input ports into the chamber to have opposite phases (e.g., the neighboring port1 and port2 inputting microwave having opposite phases of 0 and 180 degrees), to allow the microwave in the chamber to generate a second electric field distribution complementary to the first electric field distribution due to a phase change, wherein the second electric field distribution is in the form of standing waves.

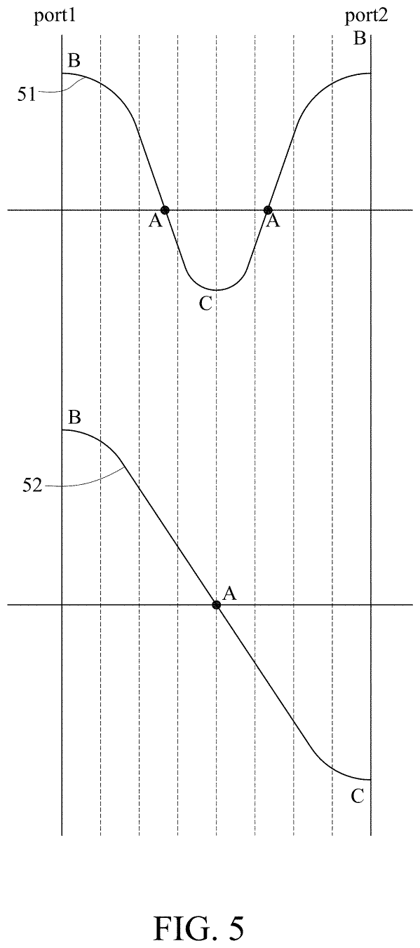

In an embodiment, in step S4 each of the phase-controlled power modules 2 sequentially adjusts the microwave of each of the input ports (e.g., port1-port4) in an direction of each orientation angle of the case 1 to have a phase difference, to allow the microwave in the chamber to generate a second electric field distribution in the form of a phase matching wave due to a phase change, and the second electric field distribution in the form of the phase matching wave complements with the first electric field distribution. Refer to FIG. 5, which shows an electric field curve diagram between an input port port1 and an input port port2 when the size of the chamber 5 of FIG. 4 is 2λ*2λ*1λ.

A first electric field curve 51 represents an electric field curve in the form of standing waves between the input port port1 and the input port port2 when the microwave of the input ports port1-port4 has the same phase. A second electric field curve 52 represents an electric field curve in the form of standing waves between the input port port1 and the input port port2 when the microwave of the neighboring ones of the input ports port1-port4 has opposite phases. A node A of the electric field curve represents a weak electric field region. The peak B or valley C in the strong electric field region are higher electric field values in the strong electric field region. The closer the strong electric field region to the node A, the smaller the electric field value becomes.

It can be known from FIG. 5 that the position of the node A of the first electric field curve 51, when at the second electric field curve 52, is located in the strong electric field region, and the position of the node A of the second electric field curve 52, when at the first electric field curve 51, is located in the strong electric field region. In other words, the complement of an electric field curve is defined as when the first electric field curve 51 overlaps the second electric field curve 52, the node A of the first electric field curve 51 is disposed in the strong electric field region of the second electric field curve 52, or the node A of the second electric field curve 52 is disposed in the strong electric field region of the first electric field curve 51. It should be understood that since standing waves oscillates in situ, the position of the node of the standing wave does not change with time. Since the input ports are the place which microwave is fed into, the first electric field curve 51 and the second electric field curve 52 in the form of standing waves located at the boundary of the input port port1 and the input port port2 are the peak B or the valley C of the highest electric field value. It can be seen from FIG. 5 that the distributions of the first electric field curve 51 and the second electric field curve 52 in a middle region between the input port port1 and the input port port2 are substantially complementary.

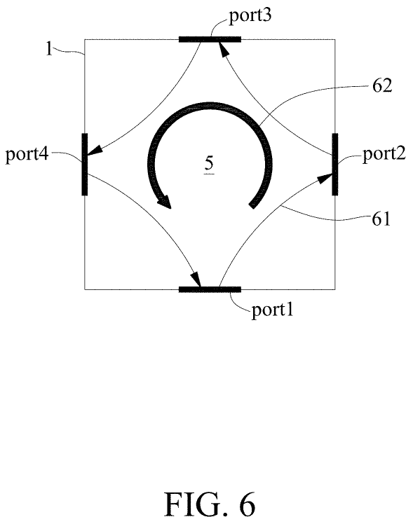

Refer to FIG. 6, which shows a schematic diagram of the phase matching wave according to this disclosure. The case 1 of FIG. 6 is a planer diagram of the case 1 of FIG. 3. Assume that the phase of the microwave provided by the input port port1 is zero degree, the phase of the microwave provided by the input port port2 is 90 degrees, the phase of the microwave provided by the input port port3 is 180 degrees, the phase of the microwave provided by the input port port4 is 270 degrees, the microwave in the form of standing waves 61 indicated by a thin arrow will be transmitted from the input port having a low phase to the input port having a high phase, and the input ports port1-port4 are disposed in a ring-shaped array on the case 1. Therefore, the microwave in the form of the standing wave 61 indicated by the thin arrow will generate a cycle from the input port port1 to the input port port4 to form a phase matching wave 62 indicated by a thick arrow. Since the phase matching wave 62 will move in the cycled path, the position of the nodes of the phase matching wave 62 will change with time.

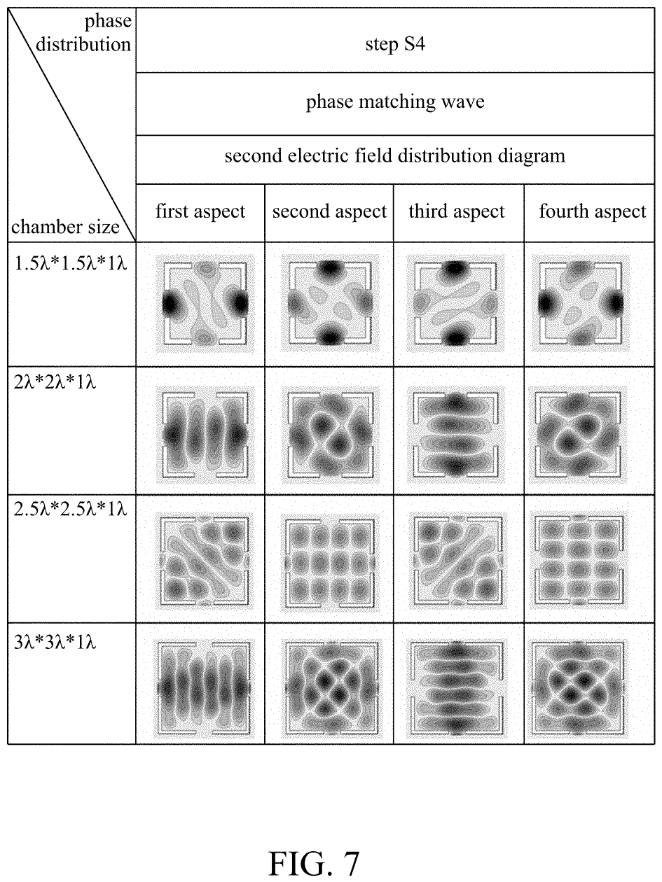

Refer to FIG. 7, which shows the diagram of the second electric field distribution of the phase matching wave of FIG. 4 in cycle of the chamber 5 of FIG. 3 according to this disclosure. The four aspects of the phase matching waves of FIG. 7 represent the phase matching waves in the cycle of the chamber 5 every 45 degrees. When the phase matching waves are in the first aspect, the phases of the phase matching waves at the input ports port1-port4 are 0, 90, 180 and 270 degrees, respectively. When the phase matching waves are in the second aspect, the phases of the phase matching waves at the input ports port1-port4 are 45, 135, 225 and 315 degrees, respectively. When the phase matching waves are in the third aspect, the phases of the phase matching waves at the input ports port1-port4 are 90, 180, 270 and 0 degrees, respectively. When the phase matching waves are in the fourth aspect, the phases of the phase matching waves at the input ports port1-port4 are 135, 225, 315 and 45 degrees, respectively.

It is known from FIG. 7 that the diagram of the second electric field distribution of four cycled aspects of the phase matching wave in the chamber 5 is complementary to the diagram of the first electric field distribution of FIG. 4.

In an embodiment, if it is desired that the phase matching waves are distributed in the chamber 5 more evenly, i.e., their electric field distribution has the feature of the best geometrical symmetry, the phase difference of the microwave of the input ports is designed as follows: N input ports are disposed on the chamber along a direction of an orientation angle; if neighboring input ports have the same phase difference therebetween, the phase difference is about (360/N) degrees or a multiple thereof; and if the phase difference is different, an angle sum of the phase differences between two pairs of input ports is about 360 degrees or a multiple thereof.

A phase matching wave is designed to be more evenly distributed in the chamber 5 of FIG. 3. Since four input ports are disposed on the chamber 5 along a direction of an orientation angle of FIG. 3, the phase difference between each of the input ports is better to be designed as 360 degrees/4=90 degrees, and the phases of the microwave of the four input ports are 0, 90, 180 and 270 degrees, respectively. It is thus known that the phase differences between the input ports port1-port4 of the phase matching waves of FIG. 4 is a better design.

In an embodiment, the phase matching waves are not limited to be provided by the input ports port1-port4, which are symmetrical ring-shaped array with respect to the horizontal and vertical directions of FIG. 3, but can also be provided by input ports in an asymmetrical ring-shaped array. For instance, as shown in FIG. 3, six input ports arranged in an asymmetrical ring-shaped array are disposed on the case 1 around the chamber 5, the better design of the phase difference between each of the input ports is 360 degrees/6=60 degrees, and the phases of microwave of the six input ports are 0, 60, 120, 180, 240 and 300 degrees, respectively.

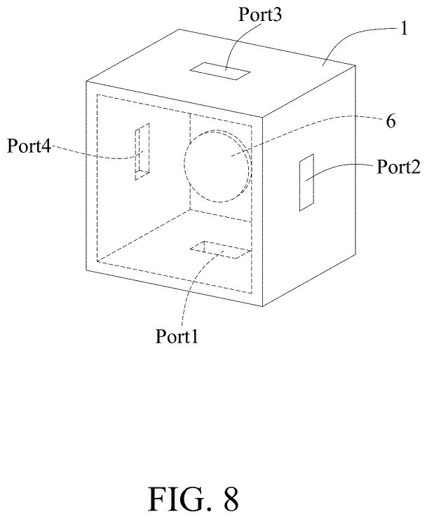

Refer to FIG. 8, which shows that a round piece, an object 6 to be heated, is placed in the chamber 5 of FIG. 3.

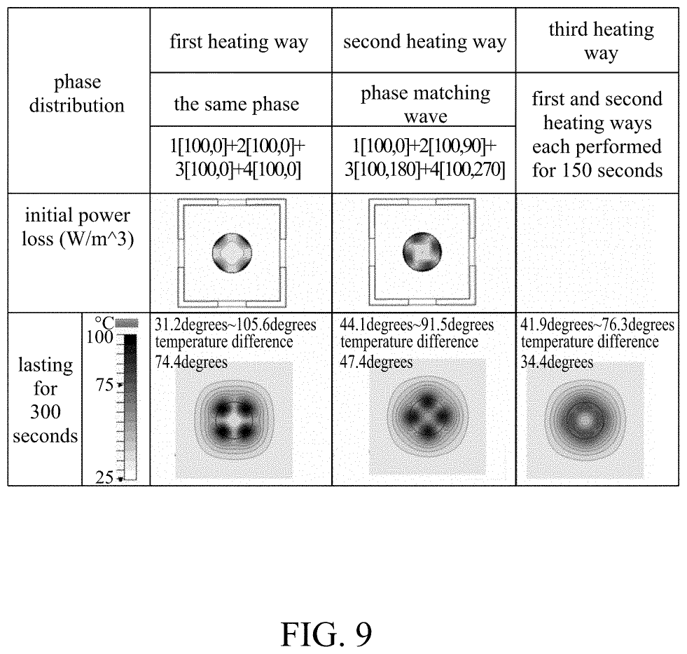

Refer to FIG. 9 at the same time, which shows the temperature distribution diagram of the object 6 to be heated of FIG. 8 in three heating ways. In FIG. 9, a round thick line represents the object 6 to be heated, different temperatures in the temperature distribution diagram are represented by different gray levels, and the temperatures from low to high are represented by gray levels from light to dark, respectively.

The first heating way: performing step S3, each of the phase-controlled power modules 2 adjusts the microwave input via each of the input ports port1-port4 into the chamber 5 to have the same phase and a power of 100 W, and the microwave is kept being input into the chamber 5 for 300 seconds to heat the object 6 to be heated. It is known from FIG. 9 that a difference between the high and low temperatures of the temperature distribution of the object 6 to be heated in the first heating way for 300 seconds is 74.4 degrees.

The second heating way: performing step S4, each of the phase-controlled power modules 2 adjusts the microwave input via each of the input ports port1-port4 into the chamber 5 to be phase matching waves and have a power of 100 W, and the microwave is kept being input into the chamber 5 to heat the object 6 to be heated for 300 seconds. It is known from FIG. 9 that a difference between the high and low temperatures of the temperature distribution of the object 6 to be heated in the second heating way for 300 seconds is 47.4 degrees.

The third heating way: performing the first heating way for 150 seconds and then performing the second heating way for another 150 seconds. It is known from FIG. 9 that a difference between the high and low temperatures of the temperature distribution of the object 6 to be heated in the first heating way for 150 seconds and then in the second heating way for another 150 seconds is 34.4 degrees. Therefore, the combination of step S3 and step S4 can solve the problem that the temperature distribution of the object 6 to be heated is more unevenly distributed if step S3 or step S4 is performed individually. In other words, the combination of step S3 and step S4 performed for a period of time can greatly reduce the temperature difference of the object 6 to be heated.

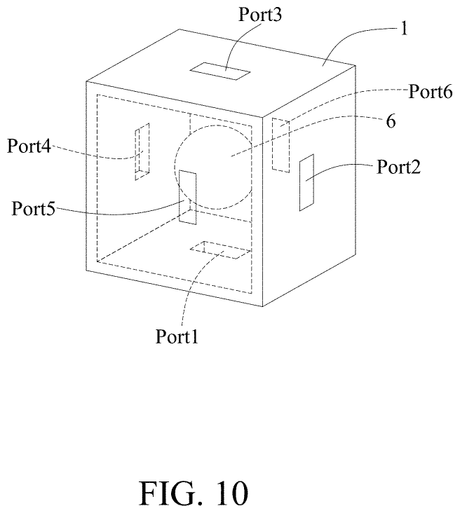

Refer to FIG. 10, which is a perspective diagram of a rectangular case 1 having a plurality of input ports disposed thereon of a second embodiment according to this disclosure. Six input ports port1-port6 in a three-dimensional array are disposed on six surfaces of the rectangular case 1 symmetrically. A sphere object 6 to be heated is placed in the chamber 5.

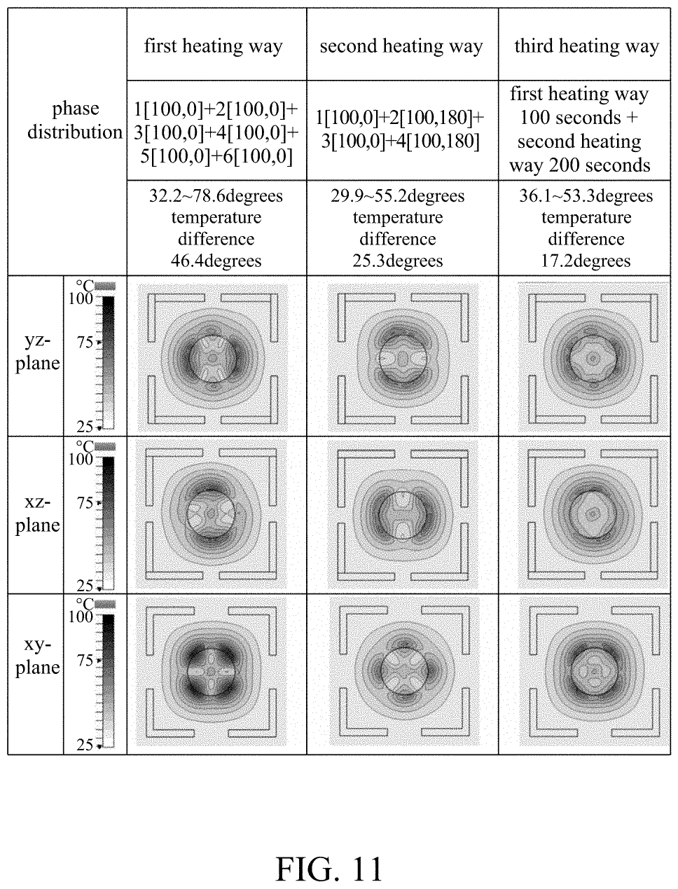

Refer to FIG. 11 at the same time, which shows the temperature distribution diagram of the object 6 to be heated in FIG. 10 in three heating ways according to this disclosure. In FIG. 11, a round thick line represents the object 6 to be heated, different temperatures in the temperature distribution diagram are represented by different gray levels, and the temperatures from low to high are represented by gray levels from light to dark, respectively.

The first heating way: performing step S3, each of the phase-controlled power modules 2 adjusts the microwave input via each of the input ports port1-port6 into the chamber 5 to have the same phase and a power of 100 W, and the microwave is kept being input into the chamber 5 for 300 seconds to heat the object 6 to be heated. It is known from FIG. 11 that a difference between the high and low temperatures of the temperature distribution of the object 6 to be heated in the first heating way for 300 seconds is 46.4 degrees.

The second heating way: performing step S4, at least one set of symmetrical input ports port5 and port6 are connected to a matching end (in an embodiment, the matching end is, but not limited to an impedance), to enable the at least one set of symmetrical input ports port5 and port6 not to provide any microwave into the chamber 5; then each of the phase-controlled power modules 2 adjusts the microwave input via the neighboring input ports port1-port4 into the chamber 5 to have opposite phases and a power of 100 W, and the microwave is kept being input into the chamber 5 to heat the object 6 to be heated for 300 seconds. It is known from FIG. 11 that a difference between the high and low temperatures of the temperature distribution of the object 6 to be heated in the second heating way for 300 seconds is 25.3 degrees.

The third heating way: the first heating way is performed for 100 seconds and then the second heating way is performed for another 200 seconds. It is known from FIG. 11 that a difference between the high and low temperatures of the temperature distribution of the object 6 to be heated in the first heating way for 100 seconds and then in the second heating way for another 200 seconds is 17.2 degrees. Therefore, the combination of step S3 and step S4 can solve the problem that the temperature is more unevenly distributed if step S3 or step S4 is performed individually. In other words, the combination of step S3 and step S4 performed for a period of time can greatly reduce the temperature difference of the object 6 to be heated.

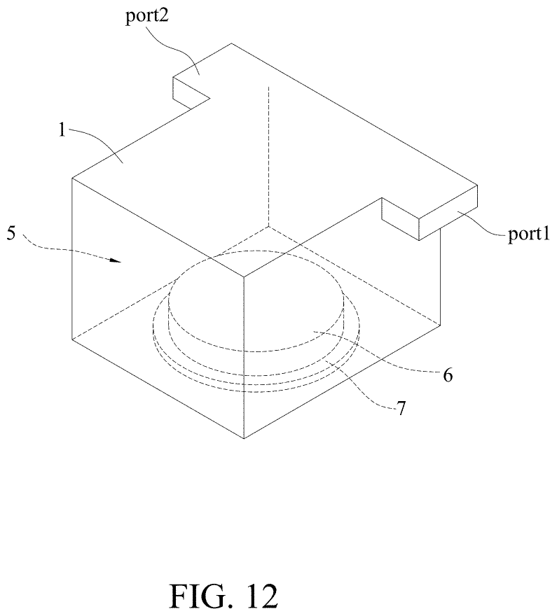

Refer to FIG. 12, which is a perspective diagram of a rectangular case 1 having a plurality of input ports disposed thereon of a third embodiment according to this disclosure. Input ports port1 and port2 arranged in a linear array are disposed on the case 1 symmetrically. A carrying platform 7 and an object 6 to be heated are placed in a central bottom of the chamber 5.

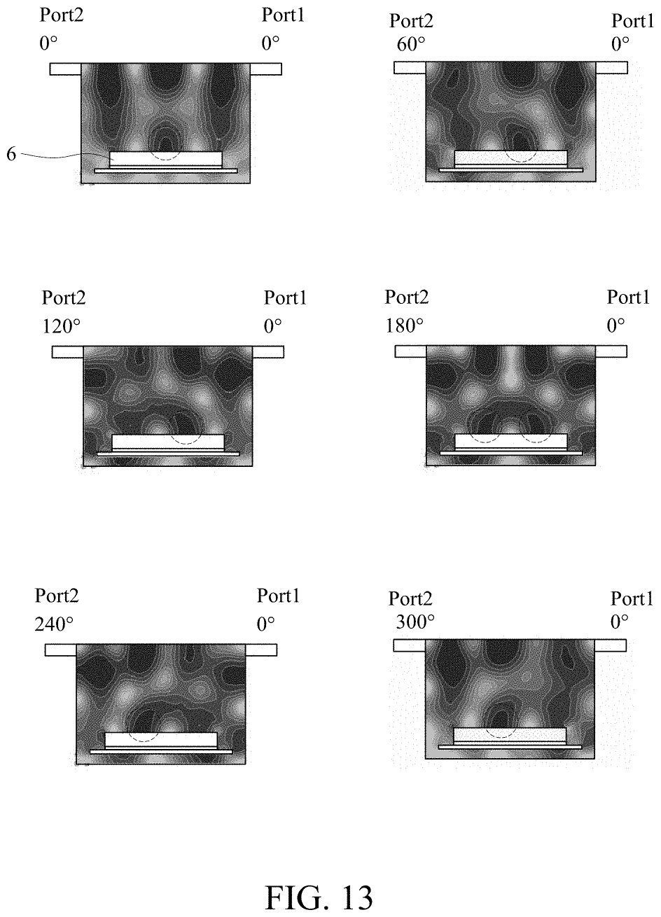

Refer to FIG. 13 at the same time, which shows a cross-sectional view diagram of an electric field distribution of a chamber of FIG. 12 after the phases of microwave of the input ports port1 and port2 are adjusted according to this disclosure. In FIG. 13, different temperatures in the temperature distribution diagram are represented by different gray levels, the temperatures from low to high are represented by gray levels from light to dark, respectively, and a dashed circle represents a strong electric field region on a surface of the object 6 to be heated. It can be known from FIG. 13 that the position of the strong electric field region on the surface of the object 6 to be heated will displace with the adjustment of the phases of the microwave of the input ports port1 and port2. Through the adjustment of the phases of the microwave at different stages, the electric fields of the microwave in the chamber 5 at different stages are distributed complementarily, to allow the object 6 to be heated evenly in the complementarily distributed electric fields at different stages. According to a method of distributively controlling phases of microwave of this disclosure, the phases of the microwave of the input ports can be changed in step S3, as long as the diagram of the electric field distribution in the chamber 5 in step S4 is complementary to the diagram of the electric field distribution in the chamber 5 in step 3. According to a method of distributively controlling phases of microwave of this disclosure, in addition to the above-mentioned disposition, the plurality of input ports can be disposed on the case 1 in another manners. In an embodiment, the plurality of input ports can, but not limited to, be disposed on the case 1 in an asymmetrical three-dimensional array or a ring-shaped array.

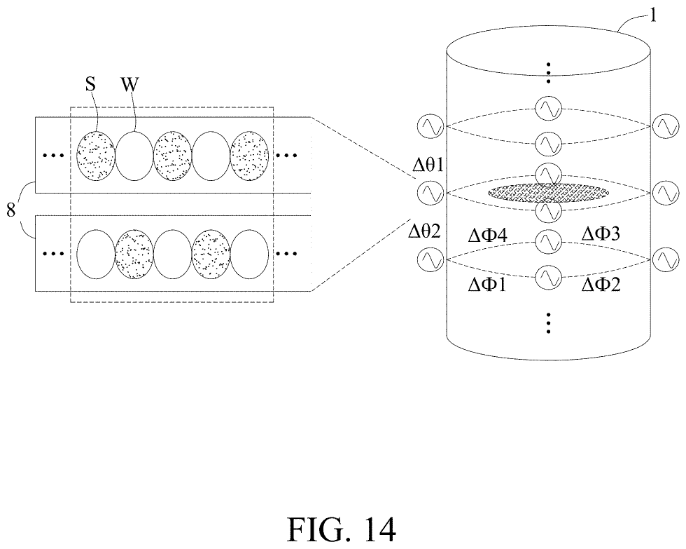

Refer to FIG. 14, which is a schematic diagram of a cylindrical case 1 to which this disclosure applied. An array of a plurality of input ports can be disposed on the cylindrical case 1 at different levels. ^{Δ}Φ1-^{Δ}Φ4 represent the phases of microwave provided by each of the input ports at a single level. ^{Δ}θ1 and ^{Δ}θ2 represent the phase differences of the microwave between the levels. In an electric field distribution 8 generated by the microwave provided by the input ports, a circle denoted by S represents a strong electric field region, and another circle denoted by W represents a weak electric field region. Through a method of distributively controlling phases of microwave according to this disclosure, the distributions of the strong electric field region and the weak electric field region can be switched, to allow an object in the electric field distribution to be heated evenly.

It can be known from the above that this disclosure employs an array of input ports distributed on the case, and the phase-controlled power modules input microwave of different phases via the input ports into the chamber to control the conversion of the strong and weak electric field distributions of the microwave in the chamber at different stages actively, to allow the electric fields of the microwave in the chamber at different stages to be distributed complementarily and allow an object to be heated more evenly in the chamber from the complementary electric field distribution at different stages. Therefore, the problem of the conventional heating way that the object cannot be heated evenly is solved.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A method of distributively controlling phases of microwave, comprising:
providing a case having a chamber inside, and forming on the case a plurality of input ports in connection with the chamber;
inputting microwave, by a plurality of phase-controlled power modules, via the input ports into the chamber to allow the microwave in the chamber to form a first electric field distribution; and
adjusting, by the phase-controlled power modules, phases of microwave signals fed into the chamber at each input port to enable the microwave in the chamber to generate a second electric field distribution complementary to the first electric field distribution due to a phase change,
wherein the second electric field distribution being complementary to the first electric field distribution indicates that when a diagram of the second electric field distribution overlaps a diagram of the first electric field distribution, a weak electric field region in a middle region of the diagram of the first electric field distribution overlaps a strong electric field region in a middle region of the diagram of the second electric field distribution, or a weak electric field region in the middle region of the diagram of the second electric field distribution overlaps a strong electric field region in the middle region of the diagram of the first electric field distribution.

2. The method of claim 1, wherein the plurality of input ports are formed on the case in a symmetrical array.

3. The method of claim 2, wherein each of the phase-controlled power modules provides the microwave of the same phase to each of the input ports, allowing each of the input ports to input the microwave of the same phase into the chamber to allow the microwave in the chamber to form the first electric field distribution.

4. The method of claim 3, wherein each of the phase-controlled power modules adjusts the microwave input via symmetrical ones of the input ports into the chamber to have opposite phases, allowing the microwave in the chamber to generate the second electric field distribution complementary to the first electric field distribution due to the phase change, wherein the first electric field distribution and the second electric field distribution are in a form of standing waves, and every node position of the standing waves does not change with time.

5. The method of claim 3, wherein each of the phase-controlled power modules adjusts the microwave input via neighboring ones of the input ports into the chamber to have opposite phases, allowing the microwave in the chamber to generate the second electric field distribution complementary to the first electric field distribution due to the phase change, wherein the first electric field distribution and the second electric field distribution are in a form of standing waves, and every node position of the standing waves does not change with time.

6. The method of claim 5, further comprising, after the first electric field distribution is generated, connecting at least one set of symmetrical ones of the input ports to a matching end, allowing the at least one set of symmetrical ones of the input ports not to provide any microwave to the chamber, and enabling each of the phase-controlled power modules to adjust the microwave input via the neighboring input ports into the chamber to have opposite phases.

7. The method of claim 3, wherein each of the phase-controlled power modules sequentially adjusts the microwave of each of the input ports along a direction of each orientation angle of the case to have a phase difference, allowing the microwave in the chamber to generate the second electric field distribution due to the phase change.

8. The method of claim 7, wherein N input ports are formed in the direction of each orientation angle of the case, and the phase difference is 360/N degrees or a multiple thereof.

9. The method of claim 7, wherein the first electric field distribution is in the form of standing waves, with a position of nodes of the standing waves not changing with time, and the second electric field distribution is in the form of a phase matching wave, with a position of every node of the phase matching wave changing with time.

10. The method of claim 1, wherein the case and the chamber are rectangular, cylindrical or polygonal.

11. The method of claim 2, wherein the symmetrical array is a linear array, a three-dimensional array or a ring-shaped array.

12. The method of claim 1, wherein the plurality of input ports on the case are formed in an asymmetrical array.

13. The method of claim 12, wherein the asymmetrical array is a three-dimensional array or a ring-shaped array.
